(19) United States
(12) Patent Application Publication
(10) Pub. No.: US 2004/0227315 A1
(43) Pub. Date: Nov. 18, 2004

(54) Cart

(75) Inventor: Alfred Reneau Van Landingham JR., Stephens City, VA (US)

Correspondence Address: FOLEY AND LARDNER, SUITE 500, 3000 K STREET NW, WASHINGTON, DC, 20007, US

(73) Assignee: RUBBERMAID COMMERCIAL PRODUCTS, LLC

(21) Appl. No.: 10/772,414

(22) Filed: Feb. 6, 2004

Related U.S. Application Data
(60) Provisional application No. 60/445,465, filed on Feb. 7, 2003.

(51) Int. Cl. B62B 3/00

(52) U.S. Cl. 280/47.35

(57) ABSTRACT

A cart, such as a utility cart, includes a base, rolling members connected to the base, and a first platform disposed above the base. The first platform has a first surface configured to support items. The cart additionally includes a handle. The handle includes a frame extending from the first platform and a gripping member with a gripping surface projecting above a plane defined by the first surface.

### CROSS-REFERENCES TO RELATED APPLICATIONS

This application claims the benefit of U.S. Provisional Application No. 60/445,465, filed Feb. 7, 2003.

### BACKGROUND OF THE INVENTION

1. Field of the Invention

The present invention relates to a cart and, more particularly, to a cart that can be used to carry objects.

2. Description of Related Art

In a cart, the height of the cart surface may be set at a level that is comfortable for lifting heavy objects off of storage shelves. A disadvantage of conventional carts is that the handle may be located at the same height as the cart surface, which places a user of the cart in an uncomfortable position for pushing and pulling the cart. The handle may also be positioned too close to the cart, causing the user to kick the cart as he pushes the cart.

Some carts are designed to be disassembled, which enables the user to efficiently package the cart for shipping to save space during transport. After disassembly, the cart may be packaged with the top shelf laying directly on the bottom shelf. In conventional carts, however, the stacked shelves tend to slip apart causing damage to the packaging carton and the cart components.

Although it is desirable to ship carts in a disassembled state to save space during transport, some carts cannot be disassembled for shipping. For example, carts with drawers must be shipped fully assembled because conventional cart drawers are not configured to nest together when the drawers are removed from the cart. Therefore, the drawers take up the same amount of space regardless of whether the cart is assembled or disassembled. Thus, conventional carts with drawers cannot be disassembled for efficient packaging.

Another disadvantage of conventional carts is that when conventional carts arrive at their shipment destination and are assembled, the joints between the legs of the cart and the bottom shelf are visible on the outside of the cart. The visible joints make the cart visually unappealing. Similarly, on the interior of the cart, the joints protrude and are physically restricting, thus limiting the amount of space available on the cart.

Conventional carts may also have accessories attached to the cart. For example, such carts may have hooks for mounting such things as electrical cords and step ladders. A disadvantage of such hooks, however, is that the hooks are typically made of metal hardware with sharp edges. The sharp edges tend to catch on things when the cart is in use.

### SUMMARY OF THE INVENTION

An aspect of the present invention relates to a cart. The cart includes a base, rolling members connected to the base to moveably support the base, and a first platform disposed above the base. The first platform has a first surface configured to support items. The cart additionally includes a handle. The handle has a frame extending from the first platform and a gripping member with a gripping surface projecting above a plane defined by the first surface.

Another aspect of the present invention relates to a device that can be changed from a disassembled state to an assembled state. The device includes a first platform with a first surface for supporting items and a base connected to the first platform by a plurality of elongated support members. The base has an upwardly extending wall member and a plurality of rib elements extending upwardly from the wall member. The rib elements are configured to maintain the first platform within a desired area when the first platform is disposed on the base in the disassembled state

Another aspect of the present invention relates to a device that can be changed from a disassembled state to an assembled state. The device includes a first platform with a first surface for supporting items and a base. The base is connected to the first platform by an elongated support member extending in a substantially vertical direction. The base has an upwardly extending wall member with a receiving portion, an inner wall surface, and an outer wall surface. The elongated support member has an insertion portion, an inner support surface, and an outer support surface. The receiving portion of the base is configured to receive the insertion portion of the elongated support member so that the inner support surface of the base is substantially flush with the inner wall surface of the elongated support member when the insertion portion is received in the receiving portion.

Another aspect of the present invention relates to a cart. The cart includes rolling members and a first platform with a first surface for supporting items. The cart additionally includes a hook configured to hold items. The hook extends from the first platform and has an upper surface with a substantially U-shape in a longitudinal direction of the hook and an inverted substantially U-shape at a cross section of at least a portion of the longitudinal direction of the hook.

Another aspect of the present invention relates to a cart that can be changed from a disassembled state to an assembled state. The cart includes a base and rolling members connectable to the base to moveably support the base. The cart additionally includes a first platform with a first surface for supporting items and a connector connecting the base to the first platform such that there is a space between the base and the first platform. Drawers are supported in the space between the base and the first platform when the cart is in the assembled state. When the cart is disassembled, the drawers are configured to be nested together.

Another aspect of the present invention relates a cart. The cart includes a base, rolling members connected to the base to moveably support the base, and a first platform disposed above the base and having a first surface for supporting items. The cart additionally includes a door connected to the cart. The door is configured to rotate approximately 270 degrees from a closed position to an open position.

Another aspect of the present invention relates to a method of packaging a device that can be changed from a disassembled state to an assembled state. The method includes providing a device including a first platform, a base, and a plurality of elongated support members that can connect the base to the first platform in the assembled state. The base includes an upwardly extending wall member and a plurality of rib elements extending upwardly from the wall member. The method further includes stacking the first platform on the base such that the rib elements maintain the first platform within a desired area in the disassembled state and packaging the device for shipment.

Yet another aspect of the present invention relates to a method of packaging a cart that can be changed from a disassembled state to an assembled state. The method includes providing a cart including a base, a first platform, and a plurality of drawers. The drawers are configured to be supported between the base and the first platform in the assembled state. Additionally, each drawer includes an exterior portion configured to be received by an interior portion of another drawer. The method further includes nesting the drawers within one another in the disassembled state and packaging the cart for shipment.

### BRIEF DESCRIPTION OF THE DRAWINGS

The accompanying drawings, which are incorporated in and constitute a part of this specification, illustrate preferred embodiments of the invention and together with the description, serve to explain principles of the invention.

FIG. 1 is a perspective view of an embodiment of a cart according to the present invention.

FIG. 2 is a left side view of the cart of FIG. 1.

FIG. 3 is a right side view of the cart of FIG. 1.

FIG. 4 is a rear view of the cart of FIG. 1.

FIG. 5 is a front view of the cart of FIG. 1.

FIG. 6 is a top view of the cart of FIG. 1.

FIG. 7 is a bottom view of the cart of FIG. 1

FIG. 8 is a perspective view of a lid of the cart of FIG. 1.

FIG. 9 is a perspective view of an embodiment of a cart according to the present invention.

FIG. 10 is a rear view of the cart of FIG. 9.

FIG. 11 is a front view of the cart of FIG. 9.

FIG. 12 is a left side view of the cart of FIG. 9.

FIG. 13 is a right side view of the handle of FIG. 9.

FIG. 14 is a top view of the cart of FIG. 9.

FIG. 15 is an exploded perspective view of detail A in FIG. 1.

FIG. 16 is an exploded perspective view of an outward-facing side of the base and elongated support member shown in FIG. 15.

FIG. 17 is a perspective view of detail A in FIG. 1.

FIG. 18 is a perspective view of an outward-facing side of the base and elongated support member shown in FIG. 17.

FIG. 19 is an exploded perspective view of the cart of FIG. 1 in a disassembled state.

FIG. 20 is a perspective view of the cart of FIG. 19 showing a first platform and a base in a stacked configuration.

FIG. 21 is a left side view of an embodiment of a cart according to the present invention.

FIG. 22 is a perspective view of a handle of the cart of FIG. 21.

FIG. 23 is a rear view of the handle of FIG. 21.

FIG. 24 is a front view of the handle of FIG. 21.

FIG. 25 is a top view of the handle of FIG. 21.

FIG. 26 is a bottom view of the handle of FIG. 21.

FIG. 27 is a right side view of the handle of FIG. 21.

FIG. 28 is a left side view of the handle of FIG. 21.

FIG. 29 is a perspective view of a handle of an embodiment of a cart according to the present invention.

FIG. 30 is a rear view of the handle of FIG. 29.

FIG. 31 is a front view of the handle of FIG. 29.

FIG. 32 is a top view of the handle of FIG. 29.

FIG. 33 is a bottom view of the handle of FIG. 29.

FIG. 34 is a left side view of the handle of FIG. 29.

FIG. 35 is a right side view of the handle of FIG. 29.

FIG. 36 is a perspective view of a portion of an embodiment of a cart according to the present invention showing two hooks.

FIG. 37 is a side view of a hook of FIG. 36.

FIG. 38 is a front cross sectional view of a hook of FIG. 36 cut along the cutting plane of line A-A.

FIG. 39 is a perspective view of a portion of an embodiment of a cart according to the present invention showing a power strip.

FIG. 40 is a perspective view of an embodiment of a cart according to the present invention showing a drawer.

FIG. 41 is a perspective view of an embodiment of a cart according to the present invention showing a bank of drawers.

FIG. 42 is a perspective view of the drawers of FIG. 41 in a disassembled configuration.

FIG. 43 is a perspective view of the drawers of FIG. 41 in a nested configuration.

FIG. 44 is a perspective view of an embodiment of a cart according to the present invention showing a door.

FIG. 45 is a perspective view of the cart of FIG. 44 showing the door in an open configuration.

FIG. 46 is a left side view of the door of FIG. 44.

FIG. 47 is a right side view of the door of FIG. 44.

FIG. 48 is a top view of the door of FIG. 44.

FIG. 49 is a left side view of an embodiment of a cart according to the present invention showing two doors.

### DETAILED DESCRIPTION

Reference will now be made in detail to embodiments of the invention, examples of which are illustrated in the accompanying drawings. An effort has been made to use the same reference numbers throughout the drawings to refer to the same or like parts.

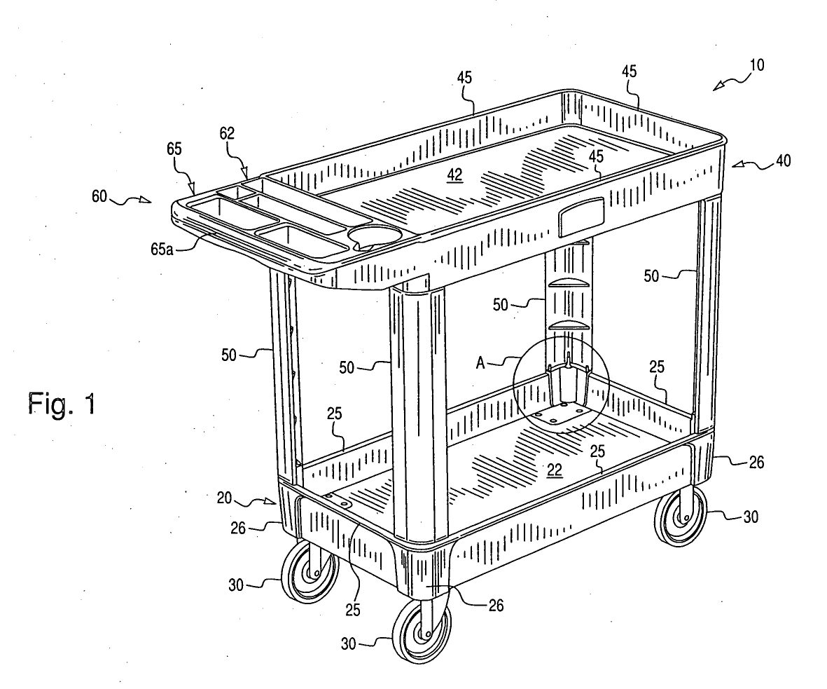

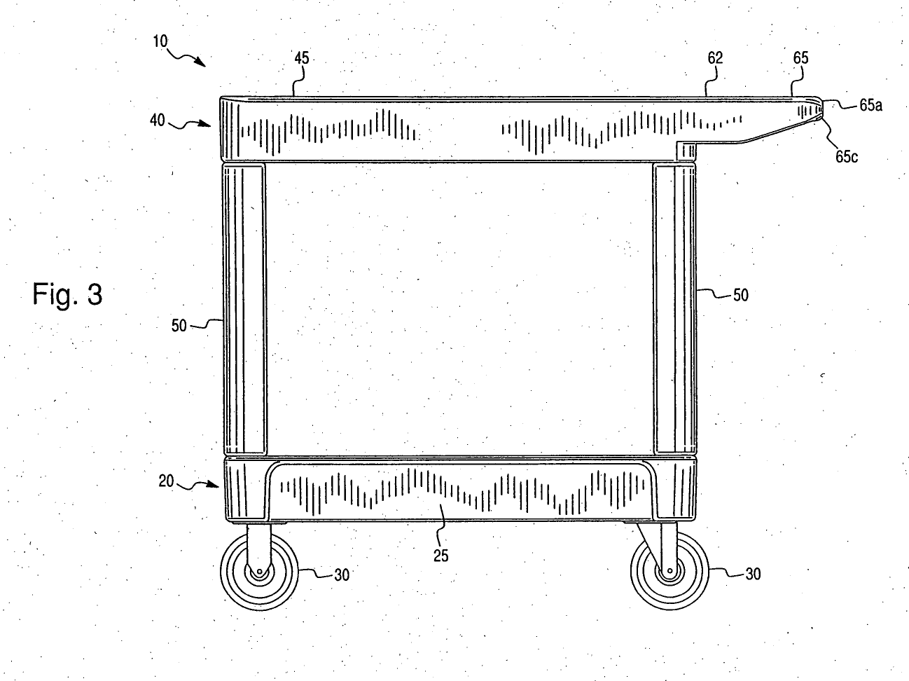

FIGS. 1 through 7 show an embodiment of a cart 10 according to the present invention. In this embodiment, the cart 10 includes a base 20, rolling members 30, a first platform 40, at least one elongated support member 50, and a handle 60.

The base 20 can form a lower portion of the cart 10, as shown in FIG. 1. In this embodiment, the base 20 includes a substantially horizontal, rectangular support surface 22 configured to support items. The base 20 can also include a plurality of upwardly extending wall members 25 disposed at a perimeter of the support surface 22. The wall members 25 can intersect to form corner portions 26. The base 20 may be formed, for example, of plastic.

The rolling members 30 are connected to the base 20. As shown in FIG. 1, a rolling member 30 can be disposed near a corner portion 26 of the base 20. The rolling members 30 are configured to movably support the base 20. For example, the rolling members 30 may be conventional casters, such as plate casters or stem casters.

The first platform 40 is disposed above the base 20 and is supported by the elongated support member 50. The first platform 40 can be similar in shape to the base 20. The first platform 40 includes a surface 42 configured to support items. The first platform 40 may also include wall members 45 extending upwardly from a perimeter of the surface 42. The wall members 45 may be disposed along the entire perimeter of the surface 42 or may only cover a portion of the perimeter. For example, one edge of the surface 42 may be left open so that a user may more easily access items supported on the surface 42. The first platform 40 may be formed, for example, of plastic.

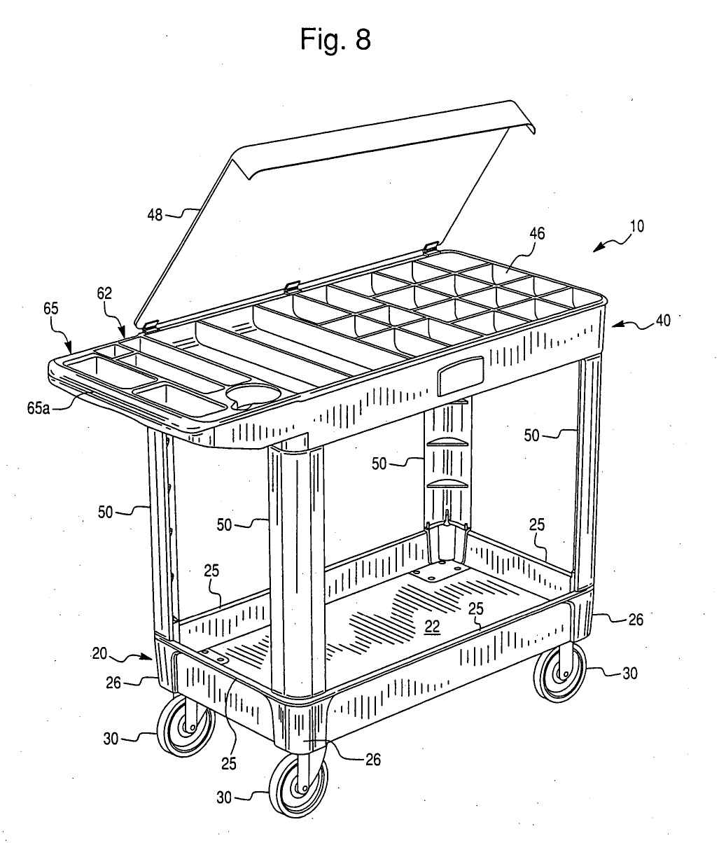

The first platform 40 may optionally include a plurality of compartments 46 recessed within the first platform 40, as shown in FIG. 8. The compartments 46 are configured so that items can be received within the compartments 46. For example, the compartments 46 can be various shapes and sizes for organizing and storing small parts, tools, and supplies. The first platform 40 may also include a lid 48 hingedly connected to an edge of the first platform so that the lid 48 is movable between an open position (shown in FIG. 8) in which the compartments 46 are exposed and a closed position (not shown) in which the compartments 46 are covered. In the closed position, an upper surface of the lid 48 can form a substantially flat and rigid work surface. The lid 48 may be formed, for example, of plastic or structural foam. The first platform 40 may also include a lip (not shown) disposed on a front edge of the first platform 40 so that a user can hang a refuse or utility bin from the lip. The cart 10 may optionally include a second platform (not shown) disposed between the base 20 and the first platform 40 and supported by the elongated support member 50.

The at least one elongated support member 50 functions as a connector that connects the base 20 and the first platform 40. As shown in FIG. 1, the cart 10 may include a plurality of elongated support members 50 disposed at each corner portion 26 of the base 20. The elongated support members 50 extend upwardly from the base 20 in a substantially vertical direction and connect to corresponding corners of the first platform 40 so that there is a space between the base 20 and the first platform 40. The elongated support members 50 may be formed, for example, of plastic.

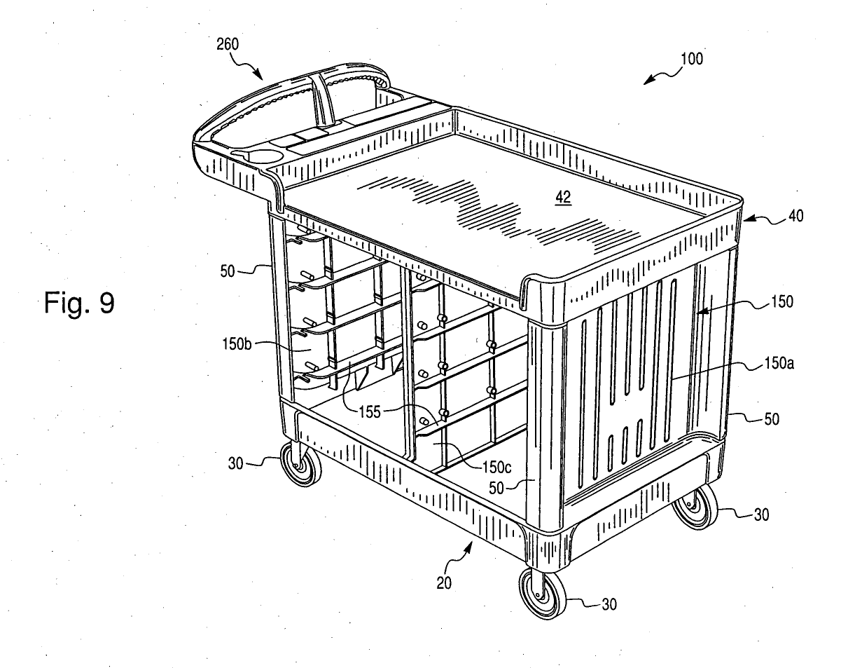

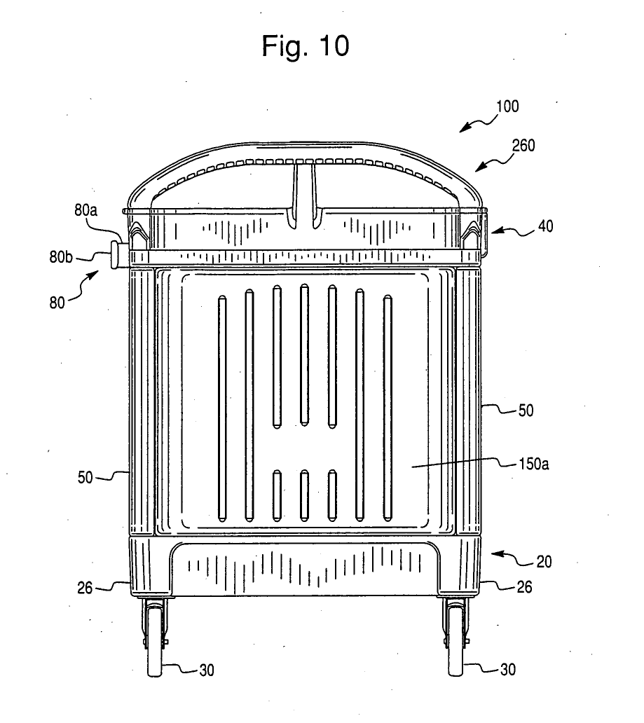

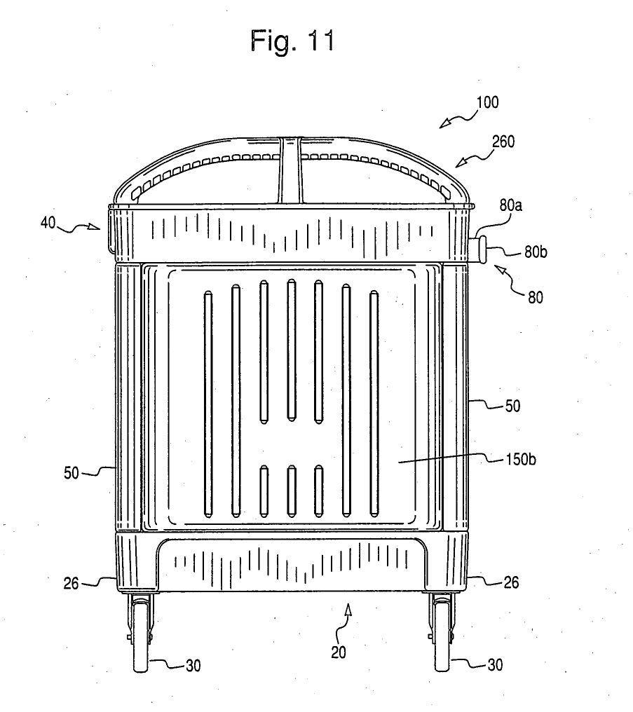

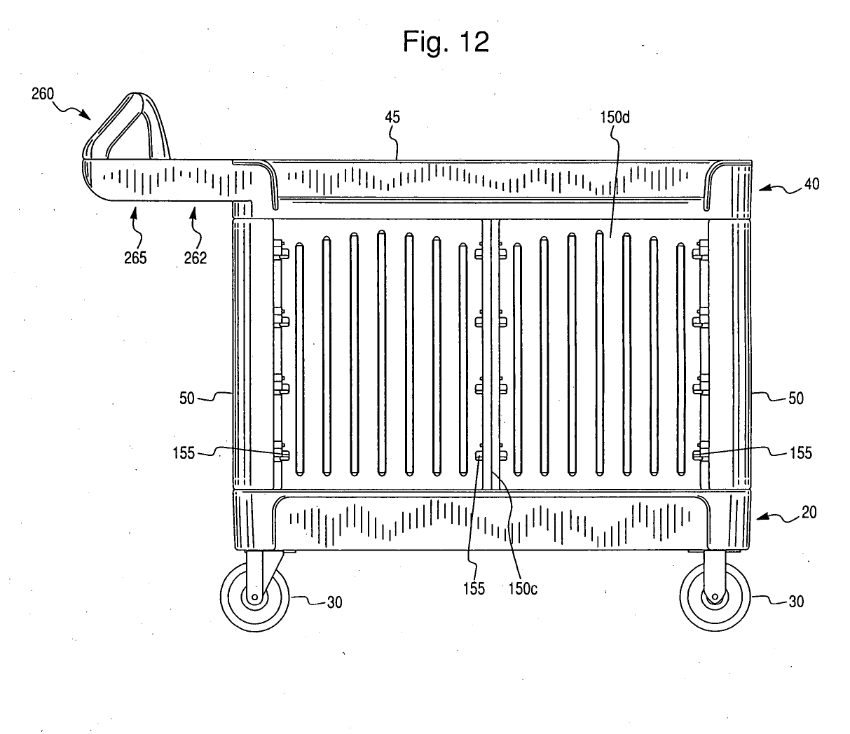

The elongated support member 50 may also include one or more end panels 150, as shown in FIGS. 9 through 13. The end panels 150 extend upwardly in a substantially vertical direction and connect the base 20 and the first platform 40 on a cart 100 (the cart 100 differs from the cart 10, as described below, but it is understood that the end panels 150 can be used with any of the disclosed carts). The end panels 150 may be formed, for example, of plastic. The end panels may be arranged in various configurations on the cart 100. For example, the cart 100 may include a first end panel 150a (shown in FIG. 10) and a second end panel 150b (shown in FIG. 11) disposed at opposite ends of the cart 100, as shown in FIG. 9. The cart 100 may also include a third end panel 150c (shown in FIGS. 9 and 12) disposed between the first end panel 150a and the second end panel 150b and a fourth end panel 150d (shown in FIG. 13) disposed on a side of the cart 100. The end panels 150 may include a reinforcement structure 155, as shown in FIG. 9.

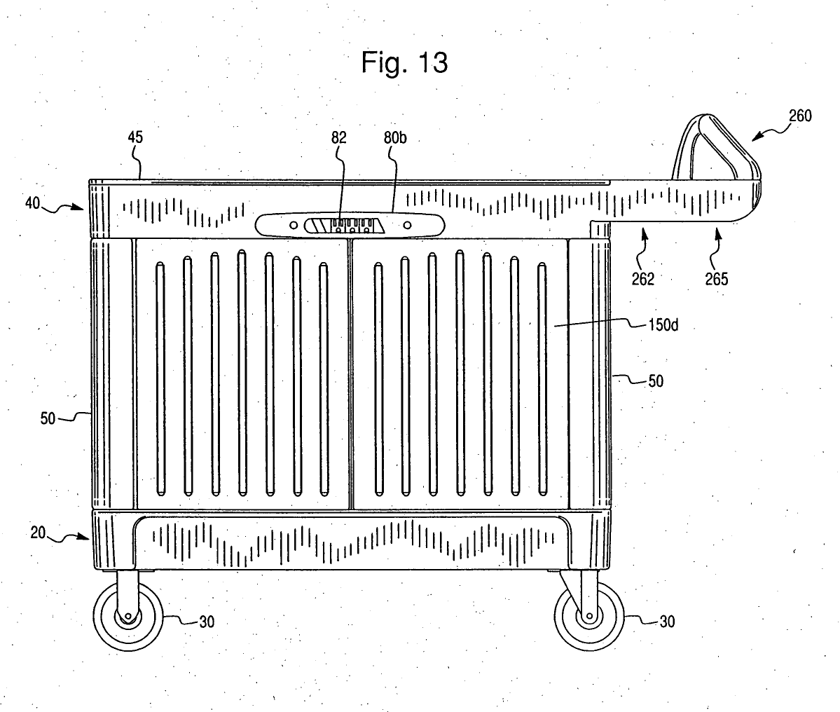

As shown in FIGS. 15 through 18, each elongated support member 50 may be configured to engage with a corresponding rib element 28 (shown in FIG. 15) disposed on the wall members 25 of the base 20. For example, an elongated support member may include a slot 58 (shown in FIG. 16) disposed on an outward facing sidewall 56 of the elongated support member 50. The slot 58 can be configured to engage with a corresponding rib element 28. The rib element 28 may extend upwardly from the corner portion 26 so that the rib element 28 is received in the slot 58 when the elongated support member 50 is assembled to the base 20. The rib element 28 and the slot 58 can be configured so that the rib element 28 and the sidewall 56 of the elongated support member 50 are substantially flush when the rib element 28 is inserted into the slot 58.

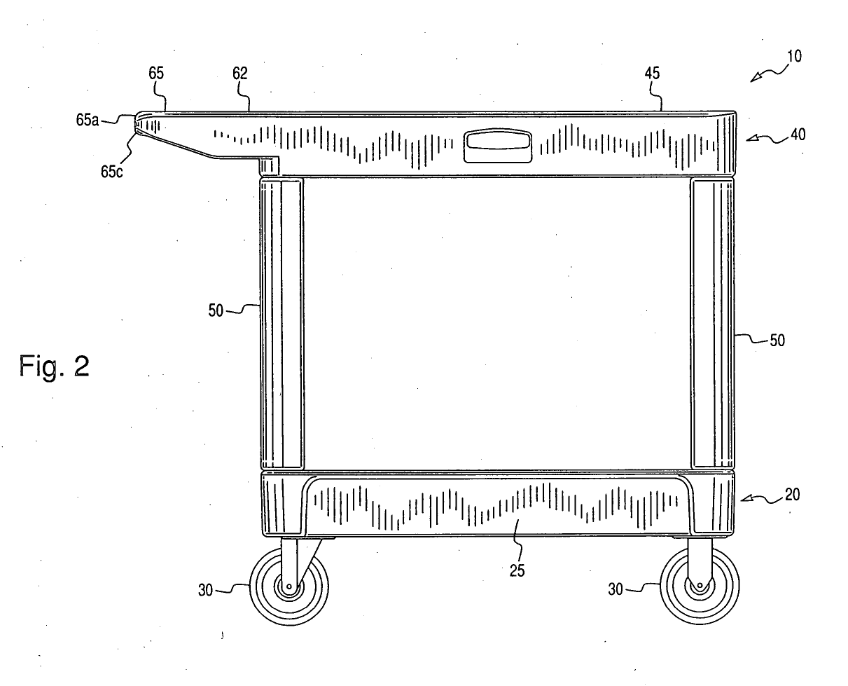

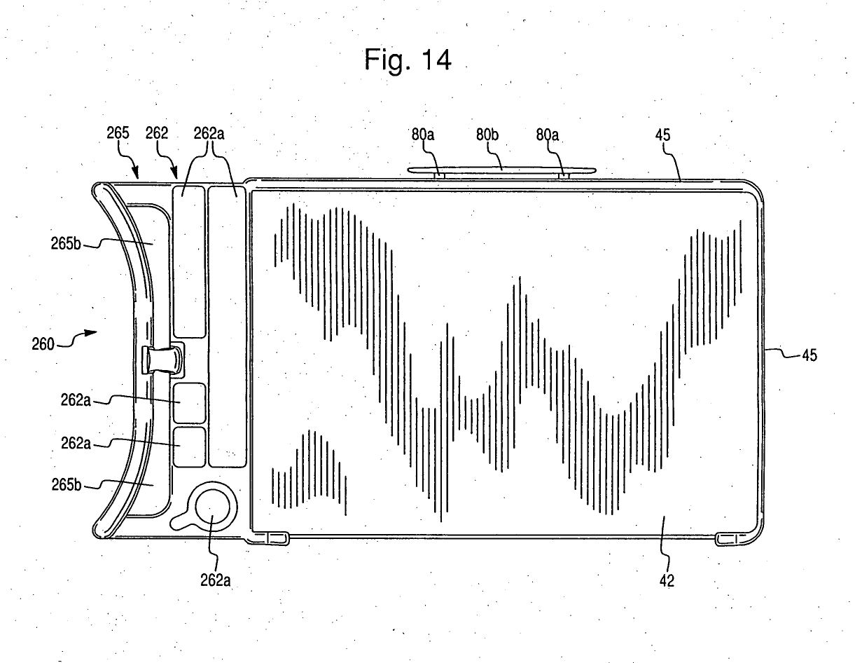

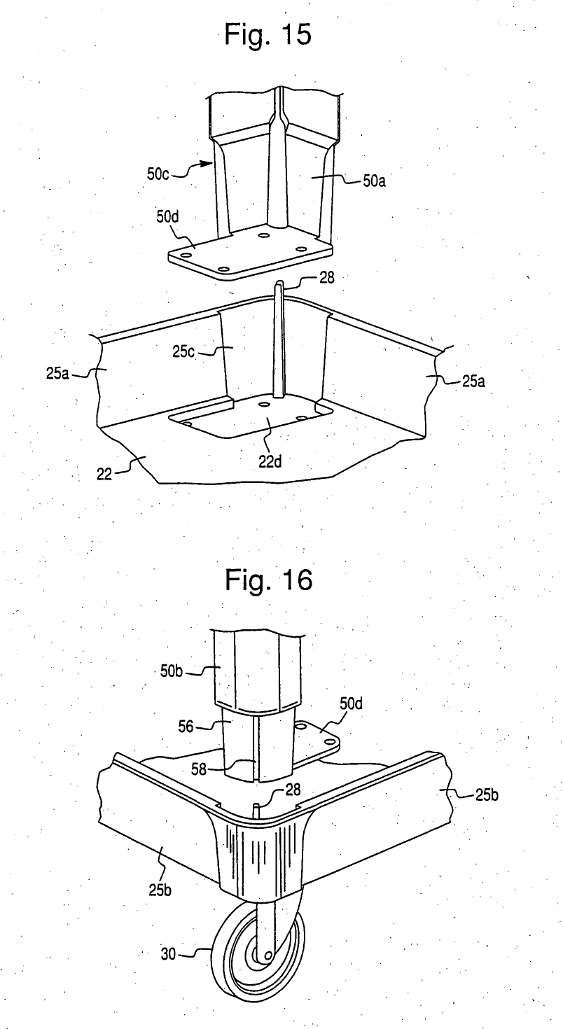

The cart 10 may also be configured so that an interior joint between the base 20 and the elongated support member 50 does not substantially protrude into a space above the support surface 22 of the base 20. For example, the wall members 25 may include an inner wall surface 25a and an outer wall surface 25b. The wall members 25 may additionally include a receiving portion 25c recessed in the inner wall surface 25a, as shown in FIG. 15. Similarly, the elongated support member 50 may include an inner support surface 50a (shown in FIG. 15) and an outer support surface 50b (shown in FIG. 16). The elongated support member 50 may additionally include an insertion portion 50c, as shown in FIG. 15. The insertion portion 50c is configured to be inserted into the receiving portion 25c of the wall members 25. For example, the receiving portion 25c and the insertion portion 50c may be configured to form a dovetail joint, which adds stability to the cart 10 by preventing the elongated support member 50 from pulling away from the base 20. When the insertion portion 50c is inserted into the receiving portion 25c, the inner support surface 50a of the elongated support member 50 is substantially flush with the inner wall surface 25a of the wall member 25 (shown in FIG. 17) and the outer support surface 50b of the elongated support member 50 is substantially flush with the outer wall surface 25b of the wall member 25 (shown in FIGS. 2 and 18). Thus, an exterior joint between the base 20 and the elongated support member 50 has a smooth transition so that the joint is not substantially visible, which is aesthetically desirable. The elongated support member 50 may additionally include a lower portion 50d (shown in FIG. 15) that is substantially horizontal. The lower portion 50d can be configured to connect to a substantially horizontal surface of the base 20. For example, the lower portion 50d can be configured to be received in a corresponding recessed portion 22d (shown in FIG. 15) disposed on the support surface 22 of the base 20. When the lower portion 50d is received in the recessed portion 22d, the lower portion 50d is substantially flush with the support surface 22 of the base 20, as shown in FIG. 17. Thus, the base 20 and the elongated support members 50 can be joined together so that the interior joints do not substantially protrude into the space above the support surface 22 of the base 20. Such a feature is advantageous because interference of the joints with a storage area of the base 20 is reduced.

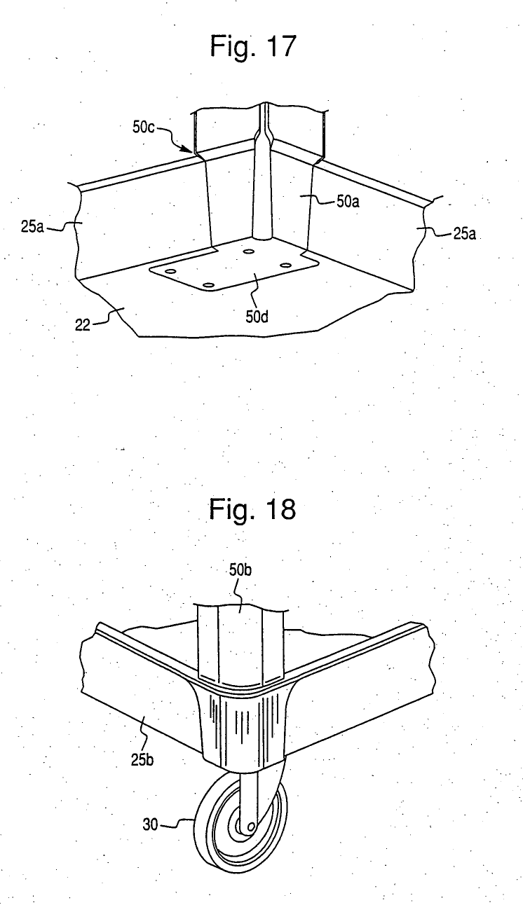

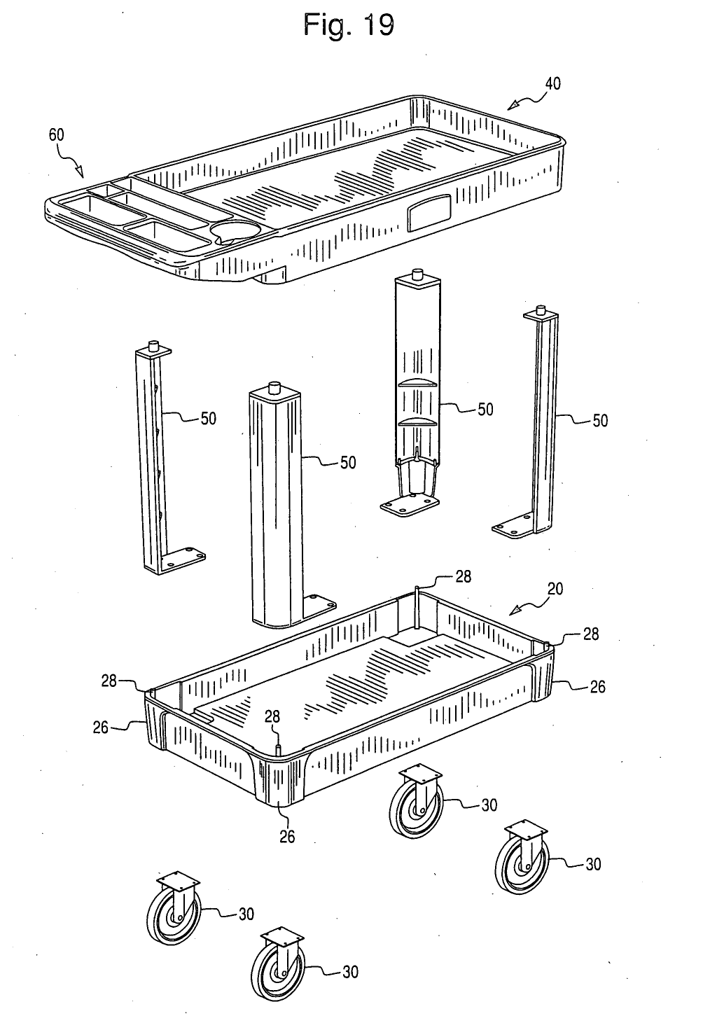

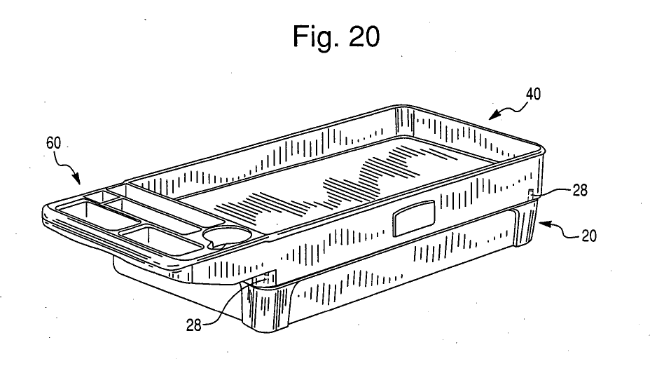

The cart 10 can be configured to be changeable from an assembled state (shown in FIG. 1) to a disassembled state (shown in FIG. 19). To disassemble the cart 10, a user disconnects the first platform 40 from the elongated support members 50 and then removes the elongated support members 50 from the base 20. The rolling members 30 can then be disconnected from the base 20. In the disassembled state, the cart 10 occupies less space than in the assembled space and can be more efficiently packaged for shipping. To package and ship the disassembled cart 10, it is desirable to stack the first platform 40 on the base 20 (shown in FIG. 20) to further reduce an amount of space occupied by the disassembled cart 10. To facilitate stacking of the first platform 40 and the base 20, the rib elements 28 can be configured to maintain the first platform 40 within a desired area when the first platform 40 is disposed on the base 20 in the disassembled state. To maintain the first platform within the desired area, the rib elements can be configured to capture the first platform 40 when the first platform 40 is stacked on the base 20. For example, the rib elements 28 may be disposed at the corner portions 26 of the base 20 so that the rib elements 28 abut against an interior portion (shown in FIG. 20) of the first platform 40 when the first platform 40 and the base 20 are in a stacked configuration. Thus, in the stacked configuration, the first platform 40 can be maintained within an area of the base 20 by the rib elements 28 in a stable manner so that the first platform 40 and the base 20 will not slip apart during transport. In this manner, the first platform 40 and the base 20 can be stacked and packaged together, and the possibility of damage to the packaging carton and cart components due to relative motion between the first platform 40 and the base 20 is prevented or reduced.

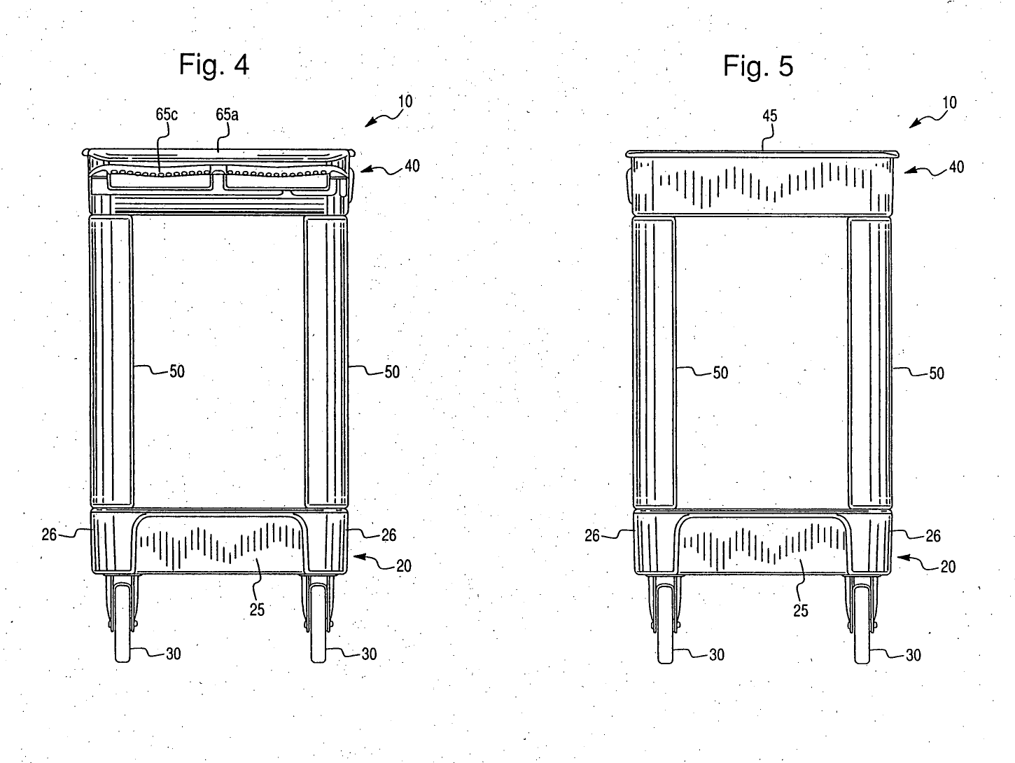

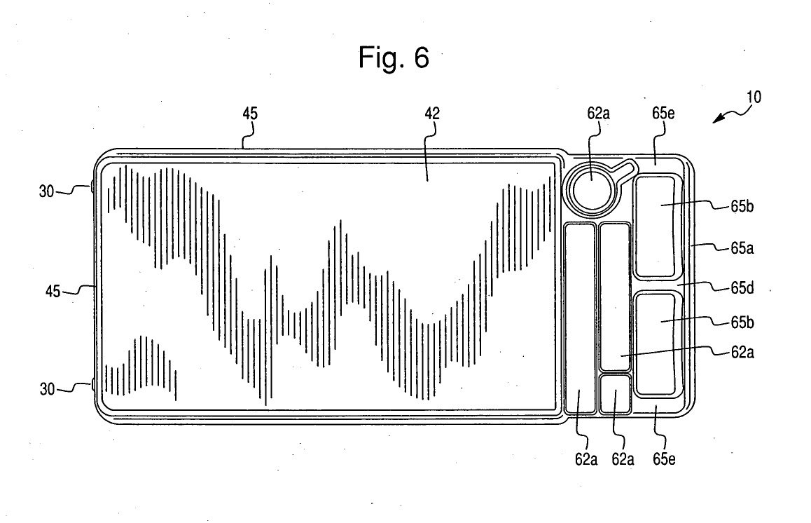

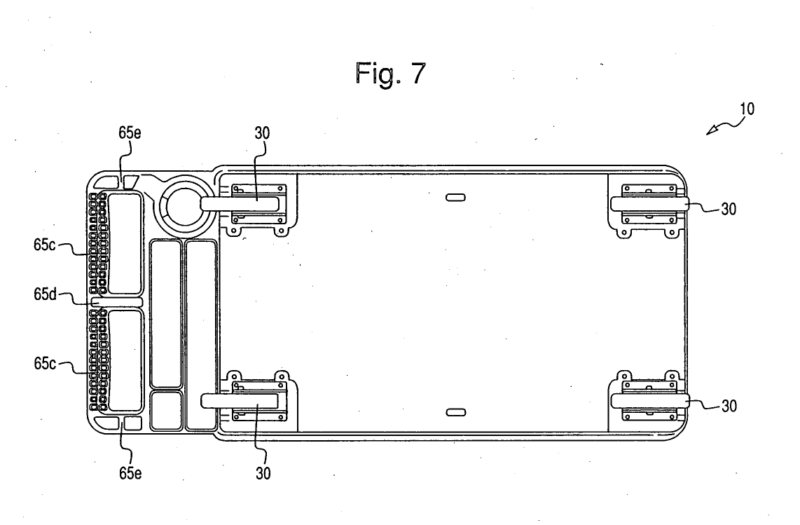

The handle 60 comprises a frame 62 and a gripping member 65, as shown in FIG. 1. The frame 62 can extend outwardly from a rear end of the first platform 40 in a substantially horizontal direction. An upper surface of the frame 62 is disposed above and is substantially parallel to a plane defined by the surface 42 of the first platform 40. The frame 62 may optionally include a plurality of recesses 62a (shown in FIG. 6) configured to receive items. For example, the recesses 62a may be configured to receive a cup, such as a coffee cup, or to hold small parts, tools, or supplies. The gripping member 65 extends from a rear portion of the frame 62 and includes a gripping surface 65a (shown in FIG. 6) configured to be grasped by a user. The gripping member 65 is connected to the frame 62 by a center support member 65d and two outer support members 65e. As shown in FIG. 1, a portion of the gripping surface 65a can be disposed above the plane defined by the surface 42 of the first platform 40. For example, the surface 42 of the first platform 40 may be located at a height of approximately 29 inches from a ground surface, and a top portion of the gripping surface 65a may be located at a height of approximately 33¼ inches from the ground surface. Additionally, the entire gripping surface 65a may be disposed above the first surface 42. The gripping member 65 is configured to receive the hands of a user. For example, the gripping member 65 may include apertures 65b, which enable a user to grasp the gripping member 65. The user may place the palms of his or her hands on the gripping surface 65a and then wrap his or her fingers through the apertures 65b and about the gripping member 65. The gripping member 65 may also include a contoured portion 65c (shown in FIGS. 4 and 7) to enable the user to more comfortably grasp the gripping member 65. The handle 60 may be formed, for example, of plastic, and may vary in width.

Thus, according to this embodiment, the portion of the handle 60 grasped by the user (i.e., the gripping surface 65a) projects above the surface 42 of the cart 10. Therefore, the surface 42 can be set at a level that is comfortable for lifting heavy objects off of the surface 42, and the portion of the handle 60 grasped by the user can be set at a level that is comfortable for the user when the user is pushing the cart. Moreover, because the gripping member 65 extends rearwardly from the frame 62, the gripping member 65 is sufficiently set back from a rear end of the cart 10 so that the user does not kick the cart 10 as he pushes the cart.

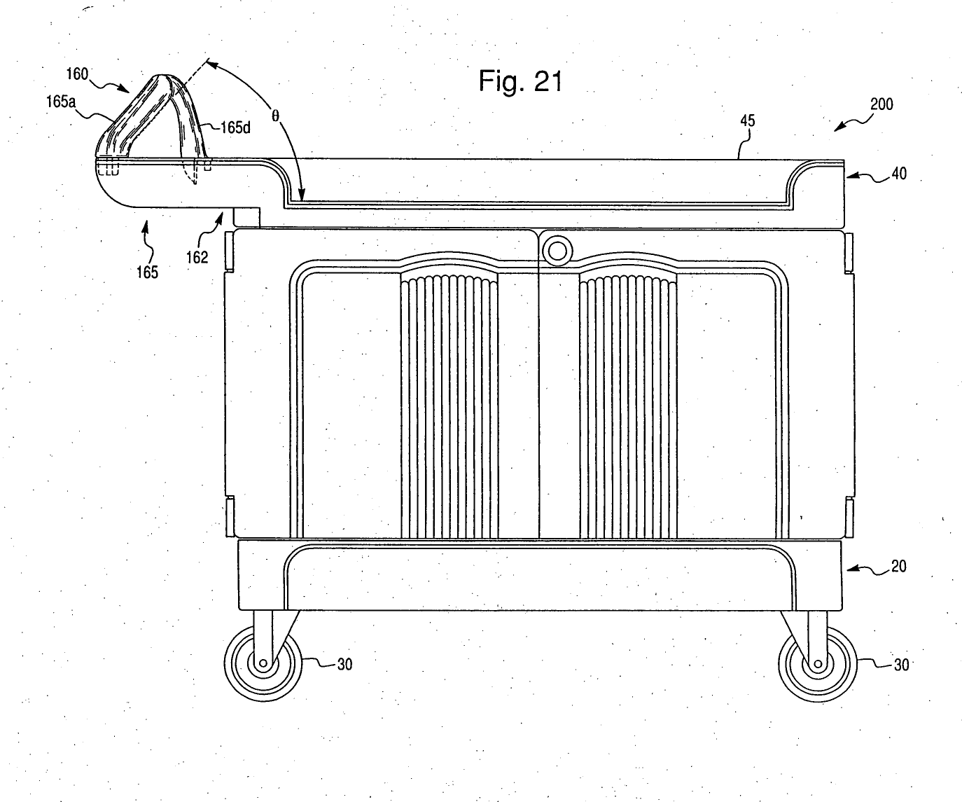

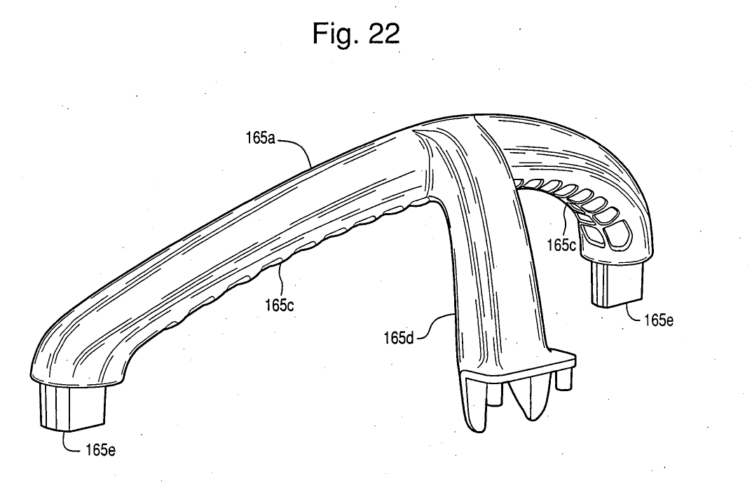

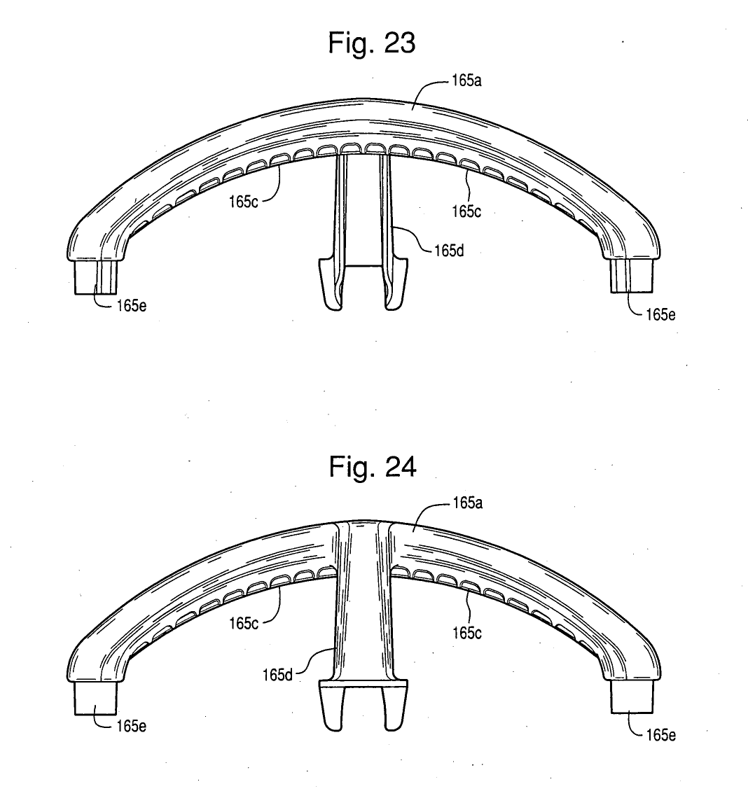

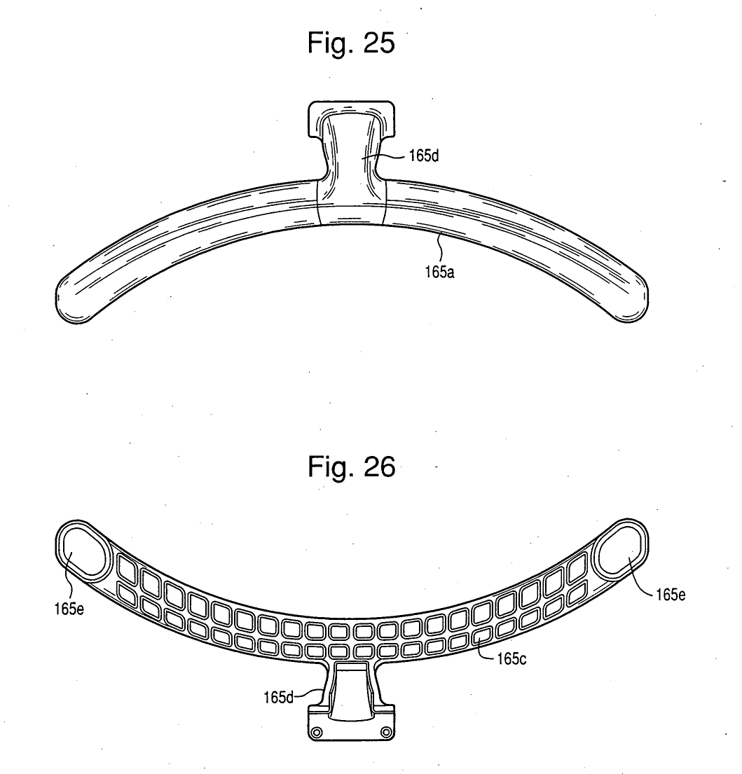

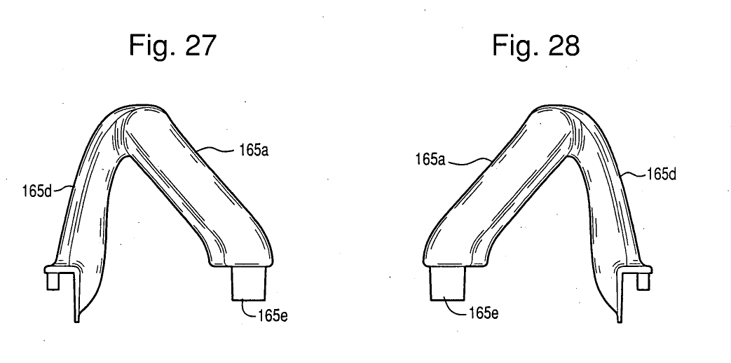

FIGS. 21 through 28 show another embodiment of a handle 160 that can be used with a cart 200 of the present invention (the cart 200 differs from the cart 10, as described below, but it is understood that the handle 150 can be used with any of the disclosed carts). The handle 160 is similar to the first embodiment except a portion of the gripping member 165 of the handle 160 is curved and angled upward. As shown in FIGS. 22 and 23, a portion of the gripping member 165 has a curved, bow-like shape such that the gripping surface 165a is substantially arcuate along a longitudinal direction of the gripping surface 165a. As shown in FIG. 21, a substantially longitudinal direction of the gripping surface 165a extends at an angle θ relative to the upper surface of the frame 162 and/or the surface 42 of the first platform 40 so that the gripping surface 165a angles upward. The angle θ may be, for example, less than 80 degrees relative to the surface 42 of the first platform 40. The gripping member 165 includes a contoured portion 165c to enable the user to more comfortably grasp the gripping member 165 and can be connected to the frame 162 by a center support member 165d and two outer support members 165e such that the entire gripping surface 165a is disposed above the surface 42 of the first platform 40. For example, the surface 42 of the first platform 40 may be located at a height in the range of approximately 28 to 34 inches from the ground surface, and a top portion of the gripping surface 165a may be located at a height in the range of approximately 33 to 39 inches from the ground surface. Thus, as in the previous embodiment, the gripping surface 165a projects above the surface 42 of the cart 200 so that the surface 42 can be set at a level that is comfortable for lifting heavy objects off of the surface 42 and the handle 160 can be set at a level that is comfortable for the user when the user is pushing the cart.

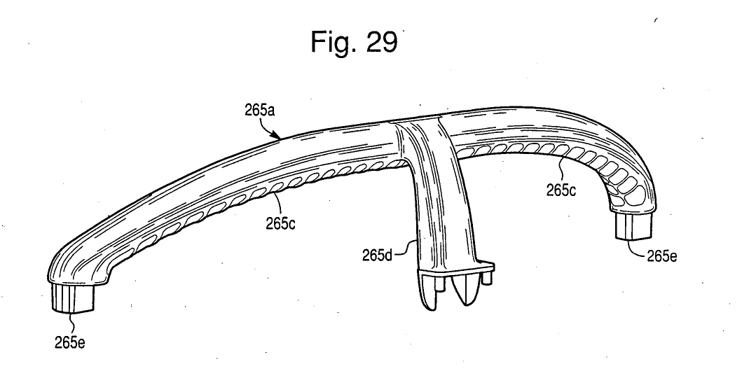

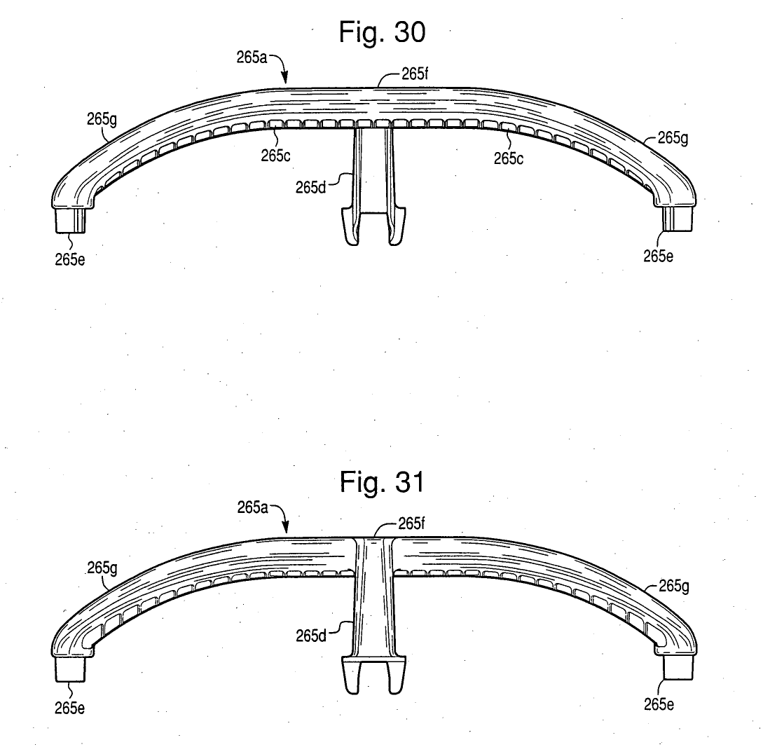

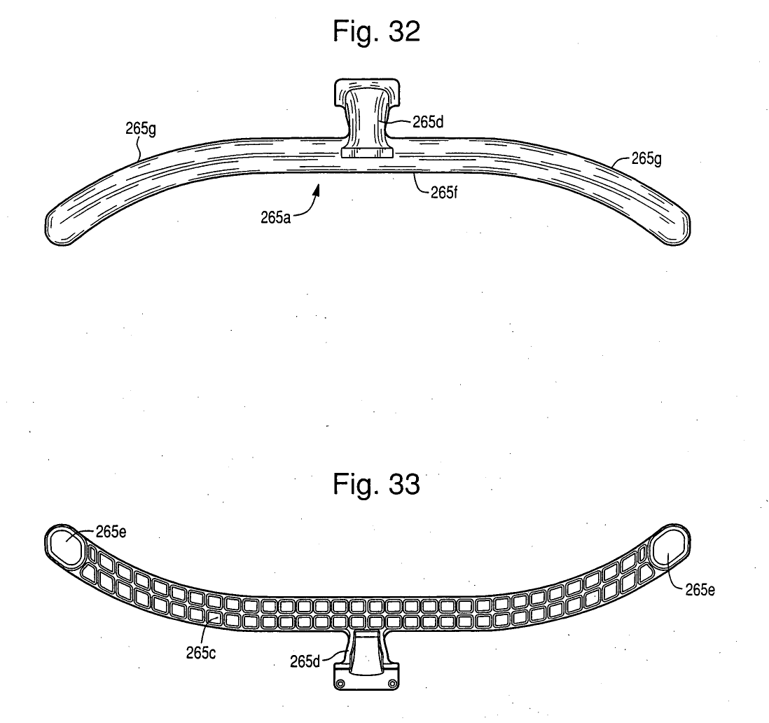

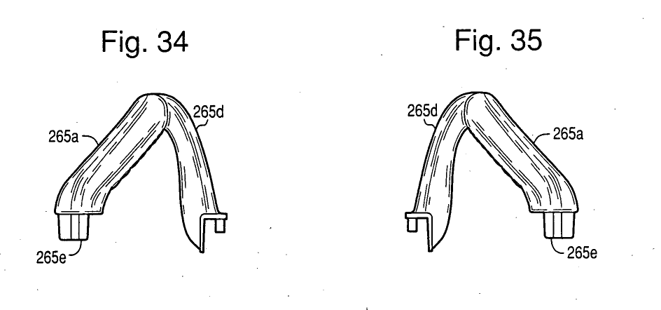

FIGS. 29 through 35 show another embodiment of a handle 260 according to the present invention. The handle of this embodiment is similar to the previous embodiments except the gripping surface 265a of the handle 260 includes a substantially straight central portion 265f (shown in FIG. 30) with curved end portions 265g disposed between the central portion 265f and the frame 262. As in the previous embodiment, the gripping member 265 can include a contoured portion 265c to enable the user to more comfortably grasp the gripping member 265 and can be connected to the frame 262 by a center support member 265d and two outer support members 265e such that the entire gripping surface 265a is disposed above the surface 42 of the first platform 40. For example, the surface 42 of the first platform 40 may be located at a height in the range of approximately 28 to 34 inches from the ground surface, and a top portion of the gripping surface 165a may be located at a height in the range of approximately 33 to 39 inches from the ground surface. Thus, as in the previous embodiments, the gripping surface 265a projects above the surface 42 of the cart so that the surface 42 can be set at a level that is comfortable for lifting heavy objects off of the surface 42 and the handle 260 can be set at a level that is comfortable for the user to push the cart.

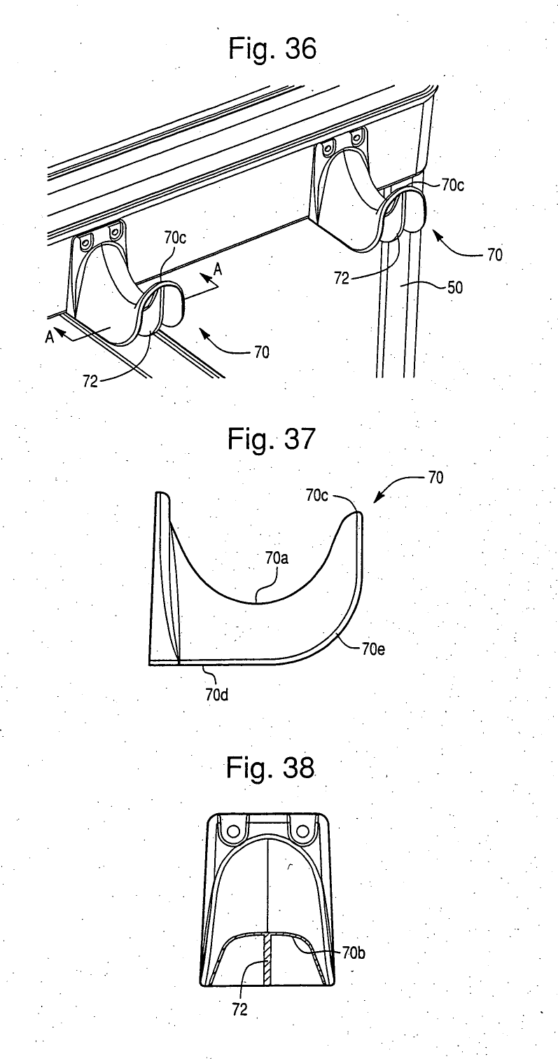

As shown in FIGS. 36 through 38, the cart 10 can be provided with hooks 70 that are configured to hold items, such as a ladder, step stool, or extension cord. The hooks 70 may be formed of a substantially smooth material, such as plastic, and are disposed on the first platform 40 spaced apart from one another (shown in FIG. 36). The hooks 70 extend outwardly from the first platform and have smooth edges. Each hook 70 has an upper surface 70a that curves smoothly in a longitudinal direction of the hook 70. The upper surface 70a can have a curvature sufficient to prevent items stored on the hook 70 from slipping off of an outward end portion of the hook 70 when the cart 10 is in motion. For example, the upper surface 70a may have a substantially U-shape (shown in FIG. 37). Similarly, an underside surface 70b of the hook 70 may be formed such that a cross-section of at least a portion of the longitudinal direction of the hook 70 has an inverted substantially U-shape (shown in FIG. 38). The underside surface 70b may also include a reinforcement rib 72 (shown in FIG. 36) extending outwardly from and along a middle portion of the underside surface 70b. Additionally, the outward end portion of the hook 70 may include a tip 70c having at least one arcuate edge region (shown in FIG. 36). A bottom edge of the hook 70 may include a substantially straight portion 70d that projects away from the first platform 40 and a substantially arcuate portion 70e disposed between the substantially straight portion 70d and the tip 70c. Thus, the upper surface 70a, the underside surface 70b, the tip 70c, and the substantially arcuate bottom edge portion 70e of the hook 70 are curved and formed of a substantially smooth material, such as plastic. Additionally, the substantially straight bottom edge portion 70d is formed of a substantially smooth material, such as plastic. Therefore, the hooks 70 have smooth edges, which prevent the hooks 70 from snagging items, such as clothing and cords. Moreover, the potential for injury to the user caused by contact with a hook having a sharp metal edge is eliminated.

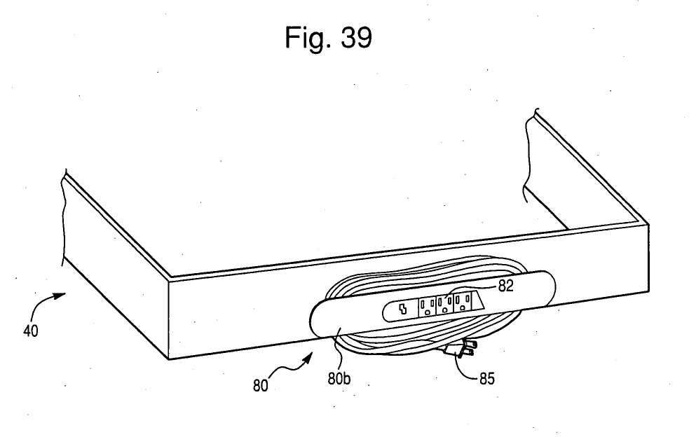

The cart 10 may optionally include a power strip 80 that can be connected to the first platform 40. As shown in FIGS. 10, 11, 13, 14, and 39, the power strip 80 can be disposed on the wall members 45 of the first platform 40 and includes at least one electrical socket 82 and an electrical cord 85 configured to engage with a power supply, such as an electrical wall socket or power generator, to provide electrical power to the power strip 80. When power is supplied to the power strip 80, the user can run an electrical accessory, such as a power drill or work lamp, by connecting the electrical accessory to the socket 82. The power strip 80 may also include a surge protector (not shown). The power strip 80 has inner members 80a and an outer member 80b. The inner members 80a are connected to the first platform 40, and the outer member 80b is connected to the inner members 80a, as shown in FIG. 14. The power strip 80 is configured so that the cord 82 may be stored on the power strip 80 when the cord 82 is not in use. For example, the cord 82 may be wrapped around the inner members 80a, as shown in FIG. 39. The cord 82 can be retained on the inner member 80a by the outer member 80b, which can be longer and wider than the inner member 80a. For example, the outer member 80b may be oblong in shape (shown in FIG. 13). Thus, the user can wrap the cord 82 about the inner member 80a so that the cord 82 is prevented from sliding off the inner members 80a by the outer member 80b. In this manner, the cord 82 can be efficiently stored on the power strip 80 when the cord 82 is not in use.

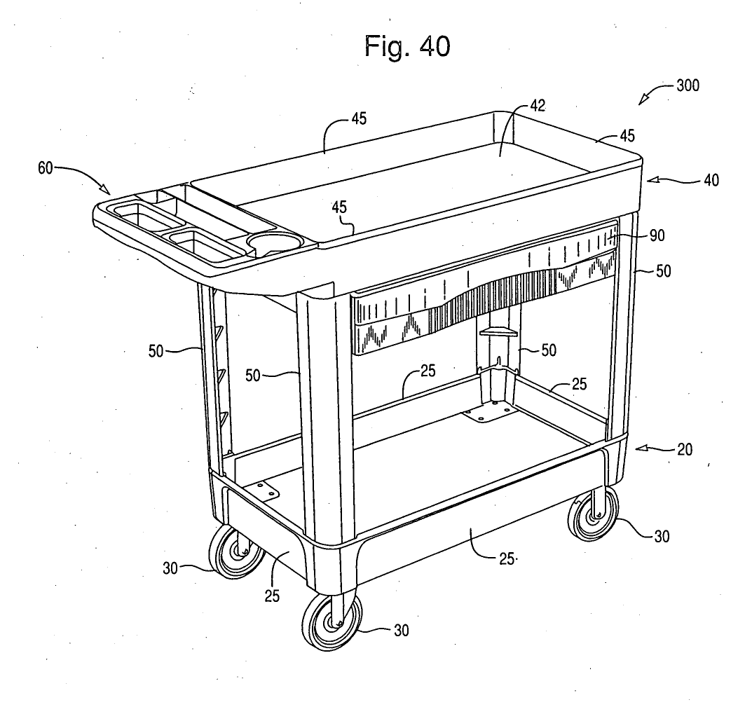

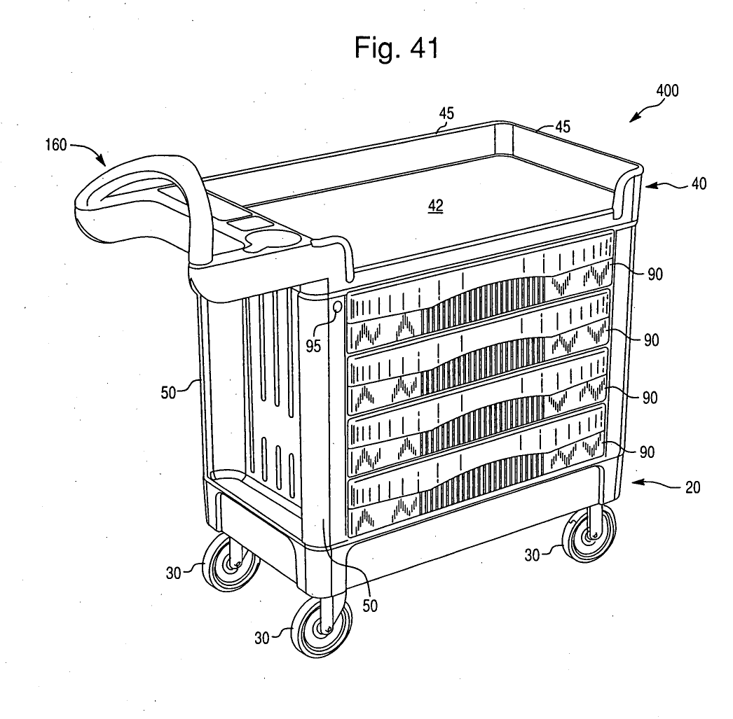

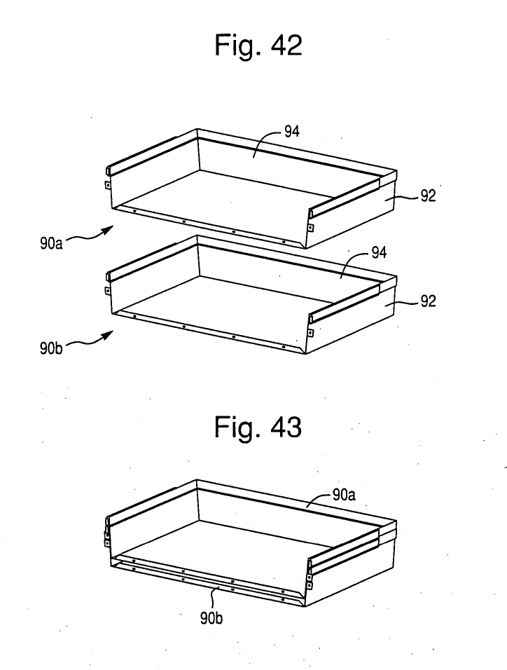

As shown in FIGS. 40 through 43, carts 300 and 400 can be provided with drawers 90 (the carts 300 and 400 differ from the cart 10, as described below, but it is understood that the drawers 90 can be used with any of the disclosed carts). The drawers 90 are supported in the space between the base 20 and the first platform 40 by use of conventional attachment hardware and are configured to be moveable between a closed position (shown in FIGS. 40 and 41) and an open position (not shown). The drawers 90 can be configured to be removed from the carts 300, 400 and nested together. For example, an exterior portion 92 (shown in FIG. 42) of a first drawer 90a can be configured to be received in an interior portion 94 (shown in FIG. 42) of a corresponding second drawer 90b so that the drawers 90a, 90b can be placed in a nested configuration, as shown in FIG. 43. The user can place the drawers 90a, 90b in the nested configuration by removing the first drawer 90a and the second drawer 90b from the cart. The user aligns the first drawer 90a with the second drawer 90b and inserts the first drawer 90a into the second drawer 90b so that the exterior portion 92 of the first drawer 90a is received within the interior portion 94 of the second drawer 90b. In the nested configuration, the first and second drawers 90a, 90b can overlap by at least approximately 2 inches. For example, the first and second drawers 90a, 90b may overlap by approximately 3½ inches. When the drawers 90 are placed in the nested configuration, an amount of space occupied by the drawers 90 is reduced. Additionally, when the drawers 90 are nested, relative motion between the drawers 90 is substantially prevented. Thus, nesting of the drawers 90 reduces an amount of space required to package the drawers 90 when the drawers 90 are removed form the cart. Thus, the ability to nest the drawers 90 enables the user to package and ship the drawers 90 in an efficient manner.

The drawers 90 may be arranged in various configurations on the carts 300, 400. For example, the drawers 90 may be located so that the drawers 90 are substantially centered horizontally under the first platform 40 between a forward and a rearward end of the first platform 40. For example, as shown in FIGS. 40 and 41, the drawers 90 may be centered between a forward elongated support member 50a and a rearward elongated support member 50b. Alternatively, the drawers 90 may be offset (not shown) toward either the forward or the rearward elongated support member 50a, 50b. Additionally, a drawer 90 may vary in width and height. For example, a drawer 90 may have a height of approximately 4⅞″. A width of the drawer 90 may be such that the drawer 90 extends from the forward elongated support member 50 to the rearward elongated support member 50 (shown in FIG. 40). Alternatively, the drawer 90 may have a smaller width (not shown). For example, the drawer 90 may have a width that is approximately one-half a distance between the forward and rearward elongated support members 50. The drawers 90 may include a single drawer 90 (shown in FIG. 40) or a bank of drawers 90 (shown in FIG. 41). The drawers 90 may optionally include a lock mechanism 95 (shown in FIG. 41) so that the user may secure the drawers 90 in a closed position. The lock mechanism 95 may be configured so that all of the drawers 90 or only a single drawer 90 are secured when the user locks the lock mechanism 95. The drawers 90 may be formed of various materials. For example, the drawers 90 may be formed substantially of sheet metal. Alternatively, a front portion of the drawers 90 may be formed of plastic while bottom, side and rear portions of the drawers 90 are formed of sheet metal.

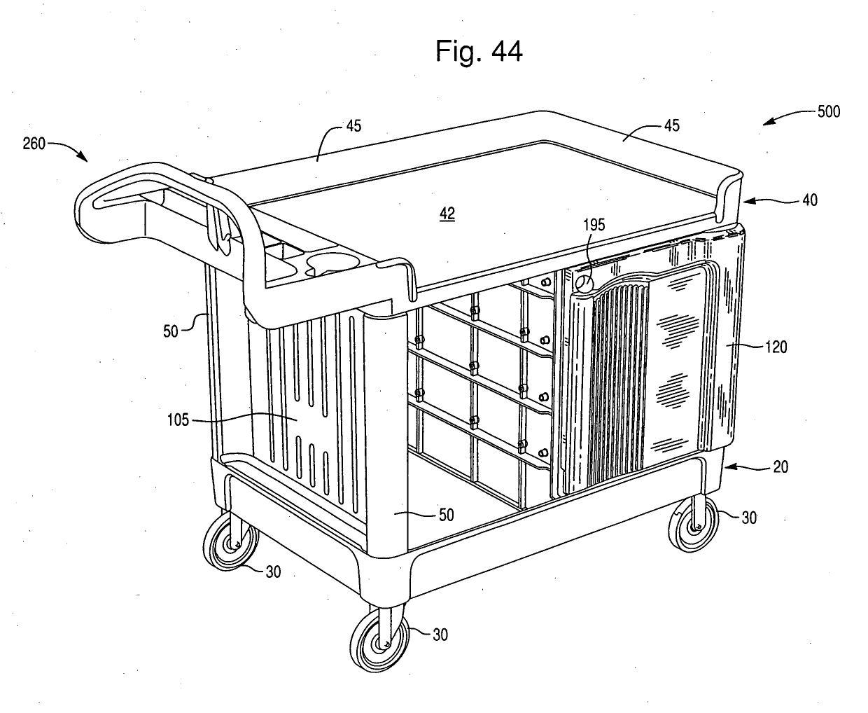

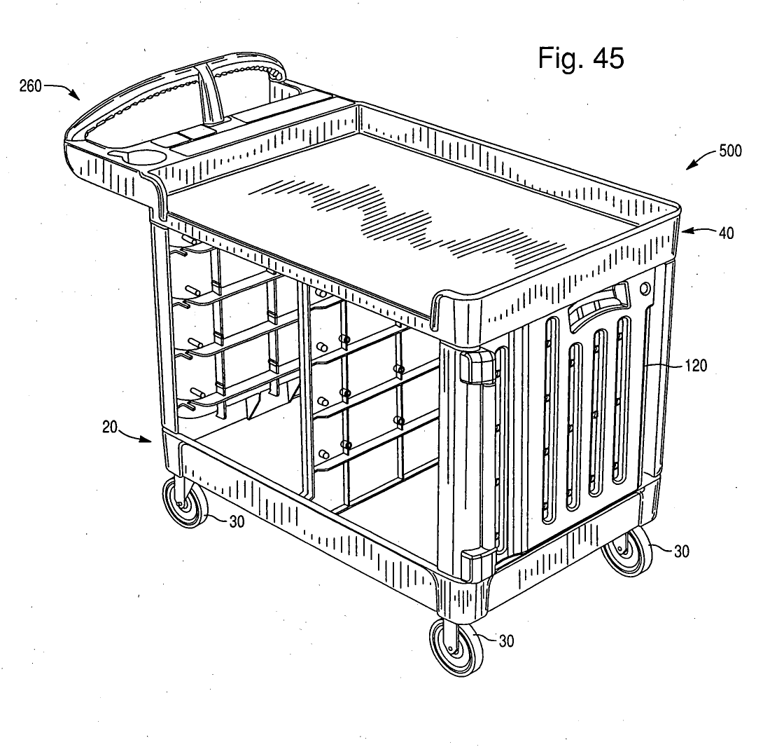

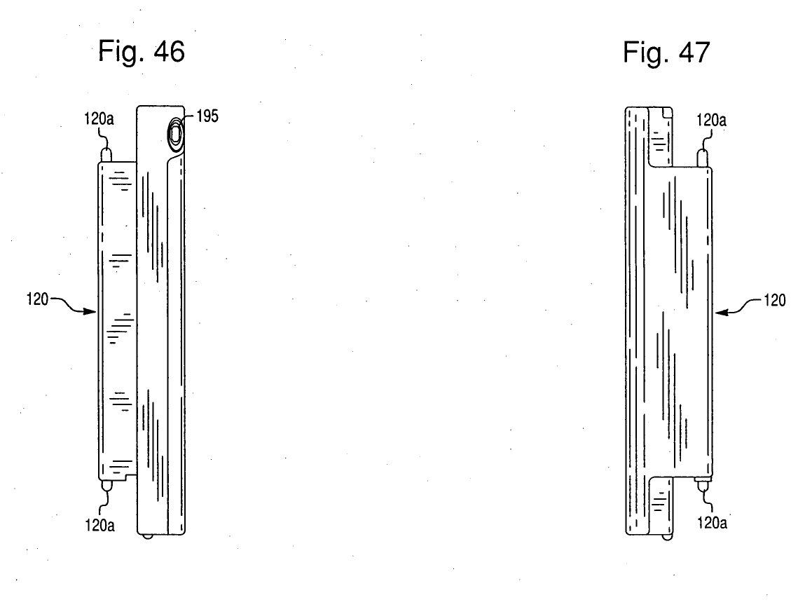

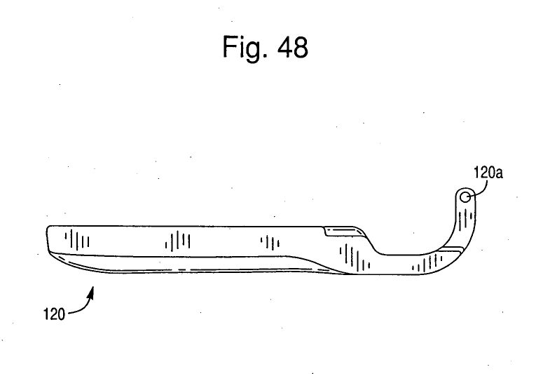

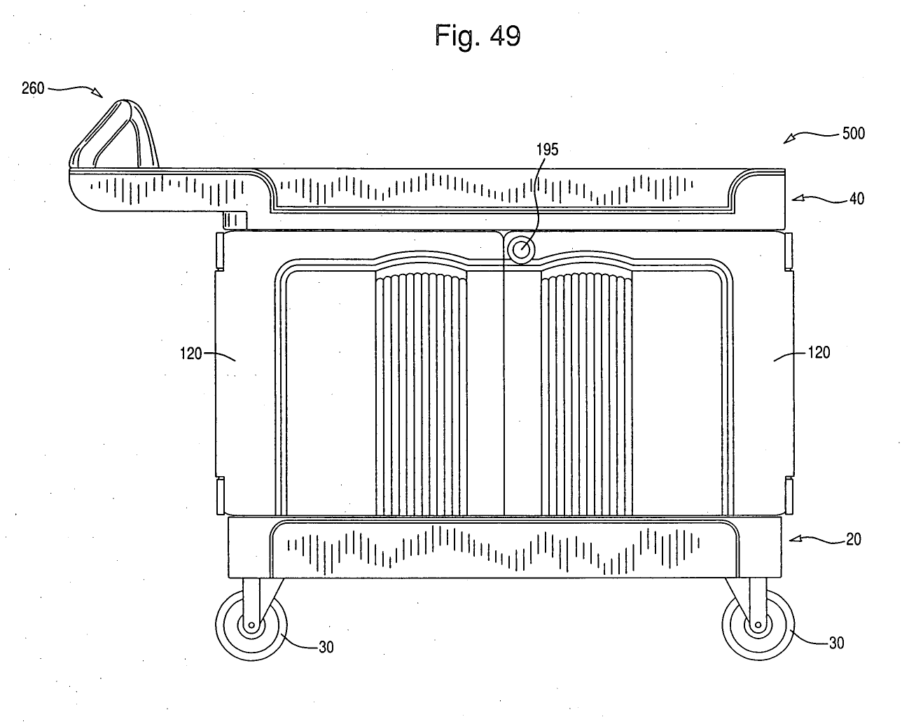

As shown in FIGS. 44 through 49, a cart 500 may also be provided with one or more doors 120 configured to be connected to a cart 500 by conventional hardware (the cart 500 differs from the cart 10, as described below, but it is understood that the doors 120 can be used with any of the disclosed carts). For example, the door 120 may include dowels 120a disposed at upper and lower connecting portions of the door 120, as shown in FIGS. 46 and 47. The dowels 120a can be configured to engage with corresponding recesses (not shown) in the base 20 and the first platform 40 so that the door 120 is moveable between a closed position and an open position. Alternatively, the door 120 may be connected to the elongated support member 50 by a hinge member. The door 120 is configured to be moveable from a closed position to an open position. For example, the door 120 can be configured to be rotated approximately 270 degrees from the closed position (shown in FIG. 44) to the open position (shown in FIG. 45). To facilitate opening of the door 120, the cart 500 may include a recessed portion 105 (shown in FIG. 44) disposed between consecutive elongated support members 50. When the door 120 is moved into the open position, the recessed portion 105 of the cart 500 provides a space into which the door 120 can rotate, which enables the door to open approximately 270 degrees. Because the door 120 can be received in the recessed portion 105, the open door 120 will be out of the way and protected from damage when the cart 500 is in use. The door 120 may be of various sizes and may be arranged on the cart 500 in various configurations. For example, the cart 500 may include a single door 120 (shown in FIG. 44) or multiple doors (shown in FIG. 49). The door 120 may be formed, for example, of plastic, and may also include a lock mechanism 195 (shown in FIG. 44) to secure the door in the closed position.

Other embodiments of the invention will be apparent to those skilled in the art from consideration of the specification and practice of the invention disclosed herein. It is intended that the specification and examples be considered as exemplary only.

What is claimed is:

1. A cart comprising:
a base;
rolling members connected to the base to moveably support the base;
a first platform disposed above the base and including a first surface for supporting items; and
a handle including a frame extending from the first platform and a gripping member with a gripping surface projecting above a plane defined by the first surface.

2. The cart of claim 1, wherein the handle is formed of plastic.

3. The cart of claim 1, wherein the frame includes a frame surface having a plurality of recesses configured to receive items.

4. The cart of claim 3, wherein the frame surface extends in a substantially horizontal direction.

5. The cart of claim 4, wherein the frame surface is disposed above and extends substantially parallel to the plane defined by the first surface.

6. The cart of claim 1, wherein a substantially longitudinal direction of the gripping surface extends at an angle of less than 80 degrees relative to the first surface.

7. The cart of claim 1, wherein the gripping surface is substantially arcuate along a substantially longitudinal direction of the gripping surface.

8. The cart of claim 1, wherein the entire gripping surface is disposed above the first surface.

9. The cart of claim 1, wherein the handle includes two outer support members and a center support member that connect the gripping member to the frame.

10. The cart of claim 1, wherein the first surface is at a height in the range of 28 to 34 inches from a ground surface and a top of the gripping surface is at a height in the range of 33 to 39 inches from the ground surface.

11. The cart of claim 1, wherein the first platform includes a plurality of compartments configured to receive items and a lid hingedly connected to an edge of the first platform, wherein the lid is movable between an open position in which the compartments are exposed and a closed position in which the compartments are covered.

12. The cart of claim 11, wherein an upper surface of the lid comprises a substantially flat and rigid work surface.

13. A device for supporting items, which can be changed from a disassembled state to an assembled state, the device comprising:
a first platform with a first surface for supporting items;
a base including an upwardly extending wall member and a plurality of rib elements extending upwardly from the wall member, wherein the rib elements are configured to maintain the first platform within a desired area when the first platform is disposed on the base in the disassembled state; and
a plurality of elongated support members for connecting the base to the first platform in the assembled state.

14. The device of claim 13, wherein the wall member includes a plurality of walls that intersect at corner portions, and the rib elements are disposed at the corner portions.

15. The device of claim 13, wherein the plurality of elongated support members each engage a corresponding rib element when the elongated support members connect the base to the first platform in the assembled state.

16. The device of claim 15, wherein each of the plurality of elongated support members includes a slot portion configured to receive the corresponding rib element.

17. The device of claim 13, further comprising rolling members connectable to the base to moveably support the base.

18. The device of claim 13, wherein the rib element is substantially flush with a sidewall of an elongated support member when the elongated support members connect the base to the first platform in the assembled state.

19. The device of claim 13, further comprising a second platform disposed between the base and the first platform, wherein the second platform is supported by the elongated support members.

20. A device for supporting items, the device comprising:
a first platform with a first surface for supporting items;
a base including an upwardly extending wall member with a receiving portion, an inner wall surface, and an outer wall surface;
an elongated support member extending in a substantially vertical direction to connect the first platform to the base, the elongated support member including an insertion portion, an inner support surface, and an outer support surface,
wherein the receiving portion receives the insertion portion, and the base and the elongated support member are configured such that the inner support surface is substantially flush with the inner wall surface when the insertion portion is received in the receiving portion.

21. The device of claim 20, wherein the base and the elongated support member are configured such that the outer support surface is substantially flush with the outer wall surface when the insertion portion is received in the receiving portion.

22. The device of claim 20, wherein the receiving portion and the insertion portion are configured to form a dovetail joint.

23. The device of claim 20, wherein the elongated support member includes a substantially horizontal portion for connecting to a substantially horizontal surface of the base.

24. The device of claim 23, wherein the base includes a substantially horizontal base surface with a recessed portion for receiving the substantially horizontal portion of the elongated support member.

25. The device of claim 20, wherein the first platform, base, and elongated support member are formed of plastic.

26. The device of claim 20, further comprising rolling members connectable to the base to moveably support the base.

27. The device of claim 20, further comprising a second platform disposed between the base and the first platform, wherein the second platform is supported by the elongated support members.

28. A cart comprising:
rolling members;
a first platform with a first surface for supporting items; and
a hook configured to hold items and extending from the first platform, wherein the hook has an upper surface with a substantially U-shape in a longitudinal direction of the hook and an inverted substantially U-shape at a cross section of at least a portion of the longitudinal direction of the hook.

29. The cart of claim 28, wherein the hook ends in a tip having at least one substantially arcuate edge region.

30. The cart of claim 29, wherein the hook has at least one bottom edge with a substantially straight portion and a substantially arcuate portion disposed between the substantially straight portion and the tip.

31. The cart of claim 28, wherein the hook is formed of plastic.

32. The cart of claim 28, further comprising a power strip connected to the first platform, wherein the power strip includes at least one electrical socket and an electrical cord configured to engage with an electrical power supply for providing power to the electrical socket.

33. The cart of claim 32, wherein the power strip includes a surge protector.

34. A cart, which can be changed from a disassembled state to an assembled state, the cart comprising:
a base;
rolling members connectable to the base to moveably support the base;
a first platform with a first surface for supporting items;
a connector connecting the base to the first platform such that there is a space between the base and the first platform; and
drawers that are supported in the space between the base and the first platform when the cart is in the assembled state, wherein the drawers are configured to be nested when the cart is in the disassembled state.

35. The cart of claim 34, wherein each drawer is formed substantially from sheet metal.

36. The cart of claim 34, wherein a first drawer and a second drawer are configured to overlap at least approximately 2 inches when the first drawer and the second drawer are in a nested configuration.

37. The cart of claim 36, wherein a first drawer and a second drawer are configured to overlap approximately 3-1/2 inches when the first drawer and the second drawer are in the nested configuration.

38. The cart of claim 34, wherein the connector includes a forward elongated support member and a rearward elongated support member and wherein the forward and rearward elongated support members extend substantially vertically and connect the base and the first platform.

39. The cart of claim 38, wherein the drawers are substantially centered between the forward and rearward elongated support members.

40. The cart of claim 38, wherein the drawers are offset toward either the forward elongated support member or the rearward elongated support member.

41. The cart of claim 34, wherein the drawers include a lock mechanism configured to secure the drawers in a closed position.

42. The cart of claim 34, wherein the drawers comprise four drawers disposed one on top of another.

43. A cart comprising:
a base;
rolling members connected to the base to moveably support the base;
a first platform disposed above the base and including a first surface for supporting items;
a door connected to the cart,
wherein the door is configured to rotate approximately 270 degrees from a closed position to an open position.

44. The cart of claim 43, wherein the cart includes a recessed portion disposed between the base and the first platform configured to receive the door when the door is in the open position.

45. The cart of claim 43, wherein an upper connection portion of the door is connected to the first platform and a lower connection portion of the door is connected to the base.

46. The cart of claim 43, wherein the cart includes at least one elongated support member extending substantially vertically and connecting the base and the first platform and wherein the door is connected to the elongated support member by a hinge mechanism.

47. The cart of claim 43, wherein the door is formed of plastic.

48. The cart of claim 43, wherein the door includes a lock mechanism configured to secure the door in the closed position.

49. A method of packaging a device, which can be changed from a disassembled stated to an assembled state, the method comprising:
providing a device including a first platform, a base, and a plurality of elongated support members that can connect the base to the first platform in the assembled state, wherein the base includes an upwardly extending wall member and a plurality of rib elements extending upwardly from the wall member;
stacking the first platform on the base such that the rib elements maintain the first platform within a desired area in the disassembled state; and
packaging the device for shipment.

50. A method of packaging a cart, which can be changed from a disassembled stated to an assembled state, the method comprising:
providing a cart including base, a first platform, and a plurality of drawers, wherein the drawers can be supported between the base and the first platform in the assembled state and each drawer includes an exterior portion configured to be received by an interior portion of another drawer;
nesting the drawers within one another in the disassembled state; and
packaging the cart for shipment.
